(19) United States
(12) Patent Application Publication
(10) Pub. No.: US 2009/0170977 A1
(43) Pub. Date: Jul. 2, 2009

(54) BUILDING BOARD MADE OF MUNICIPAL REFUSE AND AGRICULTURAL PLANT WASTES AND MANUFACTURING METHOD THEREOF

(75) Inventor: Li Wang, Beijing (CN)

Correspondence Address: YING CHEN;Chen Yoshimura LLP, 255 S. GRAND AVE., # 215, LOS ANGELES, CA, 90012, US

(73) Assignee: BEIJING HENGYECUN S&T CO., LTD., Beijing (CN)

(21) Appl. No.: 12/120,469

(22) Filed: May 14, 2008

(30) Foreign Application Priority Data
Dec. 29, 2007 (CN) 200710304733.4

(51) Int. Cl. C04B 18/04; C04B 24/26

(52) U.S. Cl. 524/2; 106/708

(57) ABSTRACT

The invention relates to a building board made of municipal refuse and agricultural plant wastes and manufacturing method thereof. The principal raw materials of the board include 200 parts of lightly-burned magnesium powder, 40 to 75 parts of magnesium chloride solution of 28 to 32 Baume degrees, 1 to 2 parts of 36-38% industrial hydrochloric acid, 80 to 120 parts of mineral materials originated from municipal refuse, 20 to 30 parts of agricultural plant wastes, and 50 to 80 parts of fly ash. The manufacturing method of the board includes preparing raw materials, preparing slurry, shaping and curing naturally. The invention uses huge amounts of mineral materials in municipal refuse and agricultural plant wastes as raw materials to making building board, and thereby realizing a recycling of these waste materials.

### BACKGROUND OF THE INVENTION

1. Field of the Invention

The invention relates to a building board and its manufacturing method, which adopts mineral materials in municipal refuse and agricultural plant wastes as the principal raw materials, and thereby realizes a resource utilization of these wastes, pertaining to a field of building materials and a field of environmental protection.

2. Description of the Related Art

The manufacture of building materials consumes massive mineral resources usually. In order to save the mineral resources, people begin to reuse wastes as raw materials, one of widely reused waste being fly ash in that the fly ash contains active ingredients and can be added as active ingredients into the cement paste to reduce cement consumption and improve product characteristics in certain conditions. Due to the development of such technology, the fly ash has been changed from a waste requiring disposal cost into a marketable material.

However, an ideal recycling mode of using municipal refuse and agricultural plant wastes has not yet been found. Currently, except a few of wastes that can be directly recycled, most of the municipal refuses are disposed by means of landfill or incineration. But the landfill needs to occupy lands and may pollute the groundwater and the air; while the incineration is energy-consuming and the flue gas produced incineration by contains harmful gases and suspended particles which are difficult for prevention and control. In the other hand, the agricultural plant wastes have not been effectively used except for being used as fuels in partial areas.

The municipal refuse comprises a plurality of elements, including plastics, paper, cloth, dried and fresh plants, wood blocks, glass, porcelains and sands, stones and dusts, etc. A feasible disposing mode is to separate and classify the municipal refuse into different materials and dispose the different materials by different methods. Especially, iron, plastics and fiber, etc. separated from municipal refuse can be recycled as industrial raw materials. But most of the residual materials such as chunks or grains of mineral materials are composed of oxides and inorganic salts which have not been effectively utilized at present.

### SUMMARY OF THE INVENTION

In order to overcome the defects in the prior art, the invention provides a building board made of the municipal refuse and agricultural plant wastes and its manufacturing method, and the building board can adopt huge amounts of mineral materials in municipal refuse and agricultural plant wastes, and thereby realize recycling of these waste materials, which is propitious to saving mineral resources and environmental protection.

The technical solution of the invention for realizing above goals is: a building board made of municipal refuse and agricultural plant wastes, wherein the principal raw materials of said board include light burned magnesium powder, magnesium chloride solution, mineral materials originated from municipal refuse, agricultural plant wastes, fly ash and hydrochloric acid.

The ratio of the principal raw materials is: 200 parts (part by weight, sic passim) of lightly-burned magnesium powder, 100 to 120 parts of magnesium chloride solution of 28 to 32 Baume degrees, 1 to 2 parts of 36-38% industrial hydrochloric acid, 80 to 120 parts of mineral materials originated from municipal refuse, 40 to 60 parts of agricultural plant wastes, and 50 to 80 parts of fly ash.

A manufacturing method of a building board, using principal raw materials of lightly-burned magnesium powder, magnesium chloride solution, mineral materials originated from municipal refuse, agricultural plant wastes, fly ash and hydrochloric acid, comprising the following procedures:

(1) preparing raw materials: crushing the mineral materials originated from municipal refuse into 100 meshes or finer; crushing the agricultural plant wastes into 80 to 100 meshes; preparing the magnesium chloride solution of 28 to 32 Baume degrees using salt-free magnesium chloride; making the fineness of the fly ash into 100 meshes or finer by screening or crushing; and insuring the effective content of the light burned magnesium powder is above 85%;

(2) preparing slurry: evenly mixing up all raw materials with water according to said ratio into slurry;

(3) shaping: pouring the slurry into a mould to form a required thickness and shape;

(4) curing naturally: placing in a natural condition for a suitable period after mould unloading.

Owing to that the raw materials of the board consist of the mineral materials originated from the municipal refuse and agricultural plant wastes, this invent turns useless materials into useful resources, not only reducing discharge of municipal refuse, lowering disposal cost of municipal refuse and saving lands occupied by garbage treatment, but also decreasing manufacturing cost of building boards and increasing economic benefit. Moreover, This building board has excellent performances of light weight, high intensity, non-deforming, waterproof, damp-proof, corrosion preventive, heat retaining, soundproof and heatproof and can be processed, nailed, drilled and sawed ideally. This building board can be used as building materials and decorate materials.

### BRIEF DESCRIPTION OF THE DRAWING

FIG. 1 is the flow diagram of a manufacturing method according to an embodiment of the present invention.

### DETAILED DESCRIPTION OF THE PREFERRED EMBODIMENTS

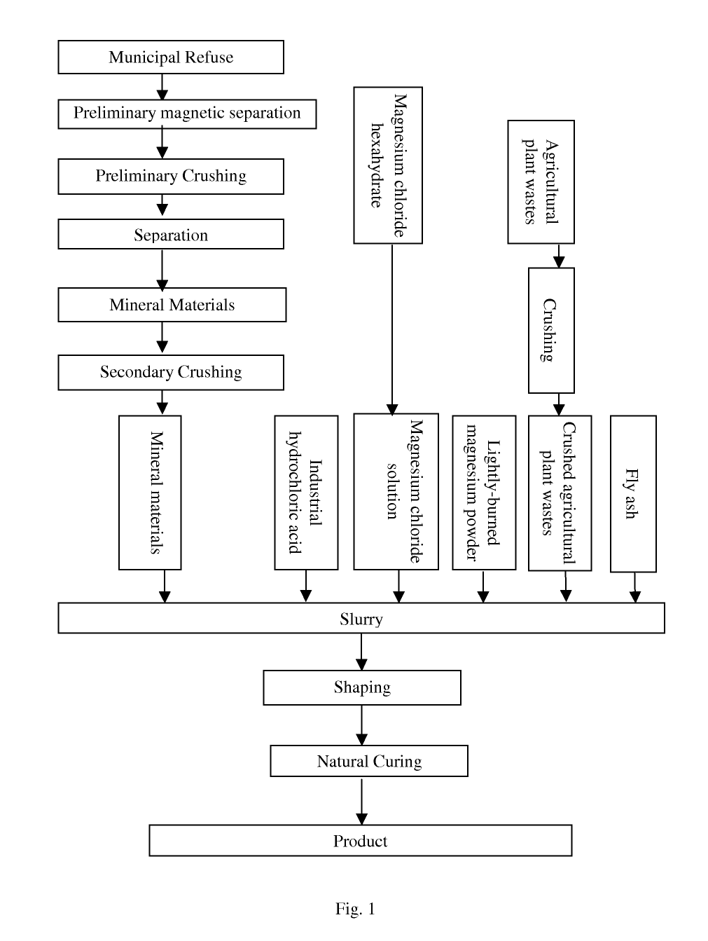

Refer to FIG. 1, the invention provides a building board made of municipal refuse and agricultural plant wastes. The principal raw materials of this board include lightly-burned magnesium powder, magnesium chloride solution, mineral materials originated from municipal refuse, agricultural plant wastes, fly ash and hydrochloric acid.

The mixture ratio of the principal raw materials is: 200 parts of lightly-burned magnesium powder, 100 to 120 parts of magnesium chloride solution of 28 to 32 Baume degrees, 1 to 2 parts of 36-38% industrial hydrochloric acid, 80 to 120 parts of mineral materials originated from municipal refuse, 40 to 60 parts of agricultural plant wastes, and 50 to 80 parts of fly ash.

The lightly-burned magnesium powder should be essentially the lightly-burned magnesium powder with the effective content no less than 85%, with 90% as the selective preference. The quality of the products made from the lightly-burned magnesium powder with an effective content below 85% will obviously drop off.

The selective preference of the magnesium chloride solution is the aqueous solution prepared by the salt-free magnesia hexahydrate or anhydrous magnesia, with the Baume degrees from 28 to 32.

The hydrochloric acid can adopt the industrial hydrochloric acid with the concentration of 36-38%.

The mineral materials originated from the municipal refuse should be crushed into 100 meshes or much finer.

The agricultural plant wastes should be crushed, with the ideal fineness ranging from 80 to 150 meshes.

The fly ash should be screened or crushed into 100 meshes or much finer.

In said raw materials, such stabilizing agents and modifying agents as urea formaldehyde resin, trisodium phosphate, naphthalenesulfonic acid, methyl-, sodium, calcium oxide, polyvinyl acetate and/or ferrous sulfate can be added. Wherein, the additional amount of the urea formaldehyde resin is 0 to 2 parts, the trisodium phosphate 0 to 0.8 part, the naphthalenesulfonic acid, methyl-, sodium 0 to 0.8 part, the calcium oxide 0 to 1.2 parts, the polyvinyl acetate 0 to 0.5 part, and the ferrous sulfate 0 to 1.2 parts.

The preparation method of the mineral materials originated from the municipal refuse is: to conduct preliminary crushing and separation of the municipal refuse to pick out the mineral materials (matters composed of various inorganic salts and inorganic metal oxides, etc.), and to conduct secondary crushing of the mineral materials into fine particles, and thereby forming said mineral materials originated from the municipal refuse.

The preliminary crushing can adopt the jaw crusher, which has a large ratio of crushing, simple structure, and equal granularity of crushed materials; moreover, the equipment in itself has simple structure, and requires relatively a larger amount of operating and maintaining costs, which is suitable for crushing the materials with complicated components and nature, such as the municipal refuse.

The preliminary crushing can, if necessary, be divided into two steps: the 1^{st} step is to adopt the jaw crusher to crush chunks into pieces, and the 2^{nd} step is to adopt a roll crusher for crushing, which is suitable for intermediate crushing and fine crushing of materials of larger rigidity.

The separation can be divided into multilevel separations. Firstly, apply the pneumatic separation or pneumatic jigging to separate the refuse materials into the heavy and the light, and then conducts the secondary jigging separation and magnetic separation of the heavy materials to separate the mineral materials.

The secondary crushing of the mineral materials can adopt a roll crusher or a ball crusher.

In the following, a plurality of embodiments of slurry mixtures is set out:

### Embodiment 1

Lightly-burned magnesium powder: 200 kg;

Magnesium chloride solution of 28 to 32 Baume degrees: 100 kg;

36-38% industrial hydrochloric acid: 1.5 kg;

Mineral materials originated from municipal refuse: 80 kg;

Agricultural plant wastes: 40 kg;

Fly ash: 75 kg;

Urea formaldehyde resin: 1 kg;

Trisodium phosphate: 0.4 kg;

Naphthalenesulfonic acid, methyl-, sodium: 0.5 kg;

Ferrous sulfate: 0.7 kg.

Calcium oxide: 0.8 kg;

Polyvinyl acetate: 0.3 kg.

### Embodiment 2

Light burned magnesium powder: 200 kg;

Magnesium chloride solution of 28 to 32 Baume degrees: 120 kg;

36-38% industrial hydrochloric acid: 2 kg;

Mineral materials originated from municipal refuse: 120 kg;

Fly ash: 50 kg;

Agricultural plant wastes: 60 kg.

### Embodiment 3

Light burned magnesium powder: 200 kg;

Magnesium chloride solution of 28 to 32 Baume degrees: 110 kg;

36-38% industrial hydrochloric acid: 1 kg;

Mineral materials originated from municipal refuse: 100 kg;

Agricultural plant wastes: 50 kg;

Fly ash: 80 kg;

Urea formaldehyde resin: 2 kg;

Trisodium phosphate: 0.8 kg;

Naphthalenesulfonic acid, methyl-, sodium: 0.8 kg;

Calcium oxide: 1.2 kg;

Polyvinyl acetate: 0.5 kg;

Ferrous sulfate: 1.2 kg;

### Embodiment 4

Light burned magnesium powder: 200 kg;

Magnesium chloride solution of 28 to 32 Baume degrees: 115 kg;

36-38% industrial hydrochloric acid: 1 kg;

Mineral materials originated from municipal refuse: 90 kg;

Agricultural plant wastes: 55 kg;

Fly ash: 50 kg;

Urea formaldehyde resin: 2 kg;

Naphthalenesulfonic acid, methyl-, sodium: 0.8 kg;

Calcium oxide: 1.0 kg;

Polyvinyl acetate: 0.3 kg.

### Embodiment 5

Light burned magnesium powder: 200 kg;

Magnesium chloride solution of 28 to 32 Baume degrees: 100 kg;

36-38% industrial hydrochloric acid: 1 kg;

Mineral materials originated from municipal refuse: 120 kg;

Agricultural plant wastes: 40 kg;

Fly ash: 60 kg;

Urea formaldehyde resin: 2 kg;

Trisodium phosphate: 0.8 kg.

The municipal refuse includes the urban household garbage and city garbage, as well as the building rubbles and decoration wastes. Owing to that the household garbage contains relatively fewer mineral materials, the mineral materials used as raw materials in the invention are mainly originated from the municipal garbage, and the so-called mineral materials refer to chunks and grains of materials mainly composed of oxides and inorganic salts, with the index of chemical composition similar to that of sands and stones, and so comes the name. The agricultural plant wastes in the invention refer to the wastes composed of dried plant corpuses, which are mainly originated from agricultural production, such as straws, haulms, and leaves, etc., and so comes the name. In addition, the non-dried plant corpuses can be dried into the agricultural plant wastes mentioned in the invention.

It will be apparent to those skilled in the art that various modification and variations can be made in the method of the present invention without departing from the spirit or scope of the invention. Thus, it is intended that the present invention cover modifications and variations that come within the scope of the appended claims and their equivalents.

What is claimed is:

1. A building board made of municipal refuse and agricultural plant wastes, wherein raw materials of the building board include lightly-burned magnesium powder, magnesium chloride solution, mineral materials originated from municipal refuse, agricultural plant wastes, fly ash and hydrochloric acid.

2. The building board of claim 1, wherein a mixture ratio of the raw materials is: 200 parts of light burned magnesium powder, 40 to 75 parts of magnesium chloride solution of 28 to 32 Baume degrees, 1 to 2 parts of 36-38% industrial hydrochloric acid, 80 to 120 parts of mineral materials originated from municipal refuse, 20 to 30 parts of agricultural plant wastes, and 50 to 80 parts of fly ash.

3. The building board of claim 2, wherein a size of the mineral materials originated from municipal refuse is 100 meshes or finer, a size of the agricultural plant wastes is 80 to 150 meshes, wherein the magnesium chloride solution of 28 to 32 Baume degrees is prepared using salt-free magnesium chloride or anhydrous magnesia, wherein a size of the fly ash is 100 meshes or finer, and wherein an effective content of the lightly-burned magnesium powder is no less than 85%.

4. The building board of claim 3, wherein a preparation method of the mineral materials originated from the municipal refuse includes: crushing the municipal refuse preliminarily and separating mineral materials from the refuse, crushing remaining materials into fine particles to form the mineral materials originated from the municipal refuse.

5. The building board of claim 4, wherein the preliminary crushing is carried out using a jaw crusher.

6. The building board of claim 4, wherein the preliminary crushing includes a first step carried out using a jaw crusher and a second step carried out using a jaw crusher or a roll crusher.

7. The building board of claim 1, wherein the raw materials are added with urea formaldehyde resin, trisodium phosphate, naphthalenesulfonic acid, sodium, calcium oxide, polyvinyl acetate and/or ferrous sulfate.

8. The building board of claim 7, wherein an amount of the urea formaldehyde resin is 0 to 2 parts, an amount of the trisodium phosphate is 0 to 0.8 part, an amount of the naphthalenesulfonic acid is 0 to 0.8 part, an amount of the sodium is 0 to 0.8 part, an amount of the calcium oxide is 0 to 1.2 parts, and amount of the polyvinyl acetate is 0 to 0.5 part, and an amount of the ferrous sulfate is 0 to 1.2 parts.

9. The building board of claim 2, wherein the raw materials are added with urea formaldehyde resin, trisodium phosphate, naphthalenesulfonic acid, sodium, calcium oxide, polyvinyl acetate and/or ferrous sulfate.

10. The building board of claim 9, wherein an amount of the urea formaldehyde resin is 0 to 2 parts, an amount of the trisodium phosphate is 0 to 0.8 part, an amount of the naphthalenesulfonic acid is 0 to 0.8 part, an amount of the sodium is 0 to 0.8 part, an amount of the calcium oxide is 0 to 1.2 parts, an amount of the polyvinyl acetate is 0 to 0.5 part, and an amount of the ferrous sulfate is 0 to 1.2 parts.

11. The building board of claim 3, wherein the raw materials are added with urea formaldehyde resin, trisodium phosphate, naphthalenesulfonic acid, sodium, calcium oxide, polyvinyl acetate and/or ferrous sulfate.

12. The building board of claim 11, wherein an amount of the urea formaldehyde resin is 0 to 2 parts, an amount of the trisodium phosphate is 0 to 0.8 part, an amount of the naphthalenesulfonic acid is 0 to 0.8 part, an amount of the sodium is 0 to 0.8 part, an amount of the calcium oxide is 0 to 1.2 parts, an amount of the polyvinyl acetate is 0 to 0.5 part, and an amount of the ferrous sulfate is 0 to 1.2 parts.

13. The building board of claim 4, wherein the raw materials are added with urea formaldehyde resin, trisodium phosphate, naphthalenesulfonic acid, sodium, calcium oxide, polyvinyl acetate and/or ferrous sulfate.

14. The building board of claim 13, wherein an amount of the urea formaldehyde resin is 0 to 2 parts, an amount of the trisodium phosphate is 0 to 0.8 part, an amount of the naphthalenesulfonic acid is 0 to 0.8 part, an amount of the sodium is 0 to 0.8 part, an amount of the calcium oxide is 0 to 1.2 parts, an amount of the polyvinyl acetate is 0 to 0.5 part, and an amount of the ferrous sulfate is 0 to 1.2 parts.

15. The building board of claim 5, wherein the raw materials are added with urea formaldehyde resin, trisodium phosphate, naphthalenesulfonic acid, sodium, calcium oxide, polyvinyl acetate and/or ferrous sulfate.

16. The building board of claim 15, wherein an amount of the urea formaldehyde resin is 0 to 2 parts, an amount of the trisodium phosphate is 0 to 0.8 part, an amount of the naphthalenesulfonic acid is 0 to 0.8 part, an amount of the sodium is 0 to 0.8 part, an amount of the calcium oxide is 0 to 1.2 parts, an amount of the polyvinyl acetate is 0 to 0.5 part, and an amount of the ferrous sulfate is 0 to 1.2 parts.

17. The building board of claim 6, wherein the raw materials are added with urea formaldehyde resin, trisodium phosphate, naphthalenesulfonic acid, sodium, calcium oxide, polyvinyl acetate and/or ferrous sulfate.

18. The building board of claim 17, wherein an amount of the urea formaldehyde resin is 0 to 2 parts, an amount of the trisodium phosphate is 0 to 0.8 part, an amount of the naphthalenesulfonic acid is 0 to 0.8 part, an amount of the sodium is 0 to 0.8 part, an amount of the calcium oxide is 0 to 1.2 parts, an amount of the polyvinyl acetate is 0 to 0.5 part, and an amount of the ferrous sulfate is 0 to 1.2 parts.

19. A manufacturing method of a building board, wherein raw materials of the building board include lightly-burned magnesium powder, magnesium chloride solution, mineral materials originated from municipal refuse, agricultural plant wastes, fly ash and hydrochloric acid, the method comprising:
(1) preparing raw materials, including crushing the mineral materials originated from municipal refuse into 100 meshes or finer, crushing the agricultural plant wastes into 80 to 100 meshes, preparing the magnesium chloride solution of 28 to 32 Baume degrees using salt-free magnesium chloride, and making fineness of the fly ash into 100 meshes or finer by screening or crushing, wherein the effective content of the light burned magnesium powder is above 85%;
(2) preparing a slurry, including evenly mixing the raw materials with water into a slurry;
(3) shaping the board, including pouring the slurry into a mould to form required thickness and shape;
(4) curing the board naturally, including placing the shaped board in a natural condition for a suitable period of time after mould unloading.
